(19) United States
(12) Patent Application Publication
(10) Pub. No.: US 2011/0307791 A1
(43) Pub. Date: Dec. 15, 2011

(54) Social Networking Application for Knowledge Sharing and Management

(75) Inventors: Lester S. Pierre, Valley Cottage, NY (US); Michael J. Russo, Staten Island, NY (US); Ridik Shrestha, Woodside, NY (US); Jeffrey A. Warren, Hoboken, NJ (US)

(73) Assignee: Wall Street Network, Inc.

(21) Appl. No.: 12/813,199

(22) Filed: Jun. 10, 2010

(51) Int. Cl. G06F 15/177; G06F 17/30

(52) U.S. Cl. 715/736; 707/771; 707/754; 707/710

(57) ABSTRACT

A web-based Social Networking Application for Knowledge Sharing and Management which provides for permissive based communication for knowledge transfer among all levels of personnel within organizations using configurable conditions and criteria for determining a target audience, or various classifications of accessible users based on configurable groups and sections. Users of such may create conversations around topics and content to be searched, tagged and published to target audiences. Users may provide commentary, ratings on conversations and commentary, or news on a particular idea or subject. Conversations may connect to combinations of text, user created conversations, images, links, web pages, attachments, internal and external content, as well as internal and external document repositories.

### BACKGROUND OF THE INVENTION

1. Field of the Invention

Organizations use a variety of methods to discover and maintain knowledge and new ideas for the benefit of its personnel and business. Most methods include manuals, books, electronic mail (email), software, etc. in order to share such knowledge. However, the majority of new ideas and discovered knowledge exists in the minds of an organization's personnel. As such, it is difficult for individuals to learn of others' ideas and communicate their own. This being the case, knowledge is not accessible by other members of an organization, especially those belonging to large organizations or organizations having multiple offices. Typically, an idea must go through levels of corporate hierarchy in order for an idea to be distributed. This hierarchy is not always helpful in determining what knowledge is required for an organization. Knowledge helpful to other personnel within the organization may be overlooked.

The present invention is a web-based knowledge management tool designed to help organizations enhance the communication and culture within their corporation, which may also be used as a client facing tool used in marketing, branding or public relations purposes and utilizes an Enterprise Content Management and Collaboration (ECMC) platform. In various implementations, the ECMC platform may be MICROSOFT SHAREPOINT 2010. The present invention is also a social networking tool for knowledge sharing among various groups of people, including personnel within an organization. This connects personnel inside an organization and allows each individual to place thoughts within the social network and target specific audiences within that organization. This allows personnel on all levels of an organization to share their knowledge and allows them to place their ideas somewhere outside of their mind where other members of the personnel can search for those ideas. Users of such may create conversations around various topics and content which encompass their knowledge and ideas. The conversations may be searched, tagged and published to target audiences within the organization. Other users may then start their own conversations around these thoughts, or comment on other's conversations. Using this application, every member of an organization may share their thoughts and ideas. The present invention may be configured to run on either internet or intranet mode depending upon the organization's needs.

The present invention contains a selected template that houses information for a systems interface. Users of such may add and maintain contents and conversations in the system. Users may provide commentary or news on a particular idea or subject. Conversations may contain a combination of text, images, links to blogs and web pages, attachments as well as other media related to the relevant topic. The present invention may be linked to a Relationship and Content Management (RCM) Tool for easy business content retrieval for attachment purposes. In various implementations, the RCM Tool may be CLEARVIEW CONTACT. This allows for the present invention to have the ability to locate, display and link content from both internal and external repositories. Users may additionally leave comments on others' conversations and rate conversations and comments in an interactive format.

The present invention is further based on users and groups as well as various sections, as the system structure is permissive based. Individual users may only see conversations and content that they have been targeted for. Target audiences are various classifications of users; a user may belong to more than one target audience. Three basic groups may be available, of which each member will be at least one, including Section Member, Section Administrator and System Owners. The privileges for each group may be different. A Section Member may have access to those items he is targeted for; a Section Administrator may additionally have administration access that is limited to the Section they are administrators for; System Owners have additional administrative privileges such as creating and managing users and permissions for the various sections.

2. Description of the Prior Art

There are other applications designed for knowledge management. Typical of these is U.S. Pat. No. 7,590,612 issued to Forrest on Sep. 15, 2009.

Another patent was issued to Dean on Oct. 27, 2009 as U.S. Pat. No. 7,610,287. Yet another U.S. Pat. No. 7,613,769 was issued to Hess on Nov. 3, 2009.

### U.S. Pat. No. 7,590,612

### Inventor: Brady D. Forrest et al.

### Issued: Sep. 15, 2009

A blog map for searching and/or navigating the blogosphere is provided. In accordance with one method for generating a blog map, a number of blog posts within the blogosphere are accessed. Each of the blog posts is converted to a feature vector, which represents the position of the blog post in a high-dimensional space. The dimensionality of the feature vectors is reduced from the high-dimensional space to a low-dimensions space, such that each blog post is represented in the low-dimensional space. A map is then generated based on the position of the blog posts in the low-dimensional space.

### U.S. Pat. No. 7,610,287

### Inventor: Jeffery Dean et al.

### Issued: Oct. 27, 2009

Communications between entities who may share common interests. For entities determined to be sharing common interests (e.g., searching using the same terms or topics, browsing a page, a site or a groups of topically related sites), options for communication among the entities are provided. For example, a chat room may be dynamically created for persons who are currently searching or browsing the same or related information. As another example, a “homepage” may be created for each query and contain various types of information related to the query. A permission module controls which entities may participate, what types of information (and from what sources) an entity can (or desires to) receive, what types of information the entity may (or desires to) share.

### U.S. Pat. No. 7,613,369

### Inventor: Duane Scott Hess

### Issued: Nov. 3, 2009

Methods and systems for providing hyperlinks to blogs that are maintained by members of a social network who have a particular association or relationship with a member of the social network in response to a request are described. A request for blog information may come from a member of the social network or from non-members. In order to gather the blog information, an association type (or association) associated with the request may be identified by a software application. After identifying the association, members of the social network who have the identified association with the member of interest may be identified using profile information associated with the member of interest. Once members having the identified association with the member of interest are identified, blog information for each identified member may be determined. Once the blog information is identified, a representation of the blog information (for example, a text-based display with hyperlinks) may be generated. The representation may then be displayed on a client device associated with the person who requested the blog information.

### SUMMARY OF THE PRESENT INVENTION

The present invention relates generally to a social networking application, and more specifically, to a Social Networking. Application for Knowledge Sharing and Management providing a solution whereby the user of such may share ideas, knowledge and content with other members of an organization's personnel.

A primary object of the present invention it to provide a social networking application for knowledge sharing and management where an organization's personnel may collaborate and share knowledge and content. Personnel within an organization have countless amounts of knowledge in their minds, and the present invention allows publication of such knowledge and content.

Another object of the present invention is to provide a social networking application for knowledge sharing and management where users may create conversations around various topics and content containing the user's knowledge and ideas. These conversations are available for viewing by other users or members of an organization.

Yet another object of the present invention is to provide a social networking application for knowledge sharing and management where user created conversations may be tagged using key words in order to provide for efficient searches by users of an organization. Once a user creates a conversation, the user may place key words in a tag cloud to link such conversation to other conversations posted by other users involving the same ideas and allow for ease of search.

Still yet another object of the present invention is to provide a social networking application for knowledge sharing and management where users may publish conversations to target audiences within an organization. The structure is permission based which allows users to view only the conversations and content that the user has been targeted for.

Another object of the present invention is to provide a social networking application for knowledge sharing and management where users are members of groups and sections within the target audiences.

Yet another object of the present invention is to provide a social networking application for knowledge sharing and management where external content may be placed within a conversation. External content may include documents and links to web pages and web logs.

Still yet another object of the present invention is to provide a social networking application for knowledge sharing and management where conversations may be rated and commented on by other users. Such ratings and comments aids in determining which users require publication authorization for related conversations.

Another object of the present invention is to provide a social networking application for knowledge sharing and management where dynamic user levels exist designating the usefulness of a user's contribution to the present invention in all knowledge areas based on tags. A user creating a conversation with certain tags and receiving high ratings on those conversations may help towards that user's level in that specific knowledge area.

Yet another object of the present invention is to provide a social networking application for knowledge sharing and management which may be linked to a user's social network profile page to provide information regarding areas an individual user is knowledgeable and skilled in. A user's Social Network Profile Page may include, but is not limited to, MY SITE user profile pages utilizing MICROSOFT SHAREPOINT technology, FACEBOOK and LINKEDIN.

The present invention overcomes the shortcomings of the prior art by providing a means for sharing knowledge with and retrieving knowledge from other members of an organization allowing for the internal distribution of ideas and content. Nowhere in the prior art exits a social networking, knowledge sharing and management application which is permission based focusing on target audiences, groups and sections to allow for regulated yet beneficial knowledge sharing. The present invention provides the interface to manage knowledge within an organization. The user of such is able to interactively communicate ideas, research and articles within the organization. Users may create, tag and publish conversations which may be rated and commented on by other users to allow for precise search mechanisms for users interested in the pertinent topic. Conversations and comments published may be monitored by Section Administrators and System Owners.

The foregoing and other objects and advantages will appear from the description to follow. In the description, reference is made to the accompanying drawings, which forms a pert hereof, and in which is shown by way of illustration of specific embodiments in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a screen shot illustrating one example of the basic features page of the present invention;

FIG. 2 is a screen shot illustrating one example of a Sections page of the present invention;

FIG. 3 is a flow diagram illustrating one example of how the present invention may build a Navigation Tree for a current user based on the user's conversations and sections;

FIG. 4 is a screen shot illustrating one example of the conversation template page a user may see when creating a conversation in the present invention;

FIG. 5 is a flow diagram illustrating one example of the process by which a Tag Cloud may be built in the present invention;

FIG. 6 is a screen shot illustrating one example of the Criteria conditions of the Target Audience Feature of the present invention;

FIG. 7 is a screen shot illustrating one example of the Criteria Conditions Menu of the present invention;

FIG. 8 is a flow diagram illustrating one example of the process followed by the Criteria conditions of the Target Audience feature of the present invention;

FIG. 9 is a screen shot illustrating one example of the inclusion of the possible target audience of Section of the present invention;

FIG. 10 is a flow diagram illustrating one example of the method for building the Select Section List of the create conversation page of the present invention;

FIG. 11 is a screen shot illustrating one example of the inclusion of the possible target audience of User/Group of the present invention;

FIG. 12 is a screen shot illustrating one example of adding related and external content to a conversation in the present invention;

FIG. 13 is a screen shot illustrating one example of the external internet search that may result by user selection of Find Related Content of the present invention;

FIG. 14 is a screen shot illustrating one example of the related and external contents links displayed within a Related Content tab of a conversation's View Conversation Page of the present invention;

FIG. 15 is a screen shot illustrating one example of the. Comments portion of the View Conversation Page of the present invention;

FIG. 16 is a screen shot illustrating one example of the administration page of the present invention;

FIG. 17 is a flow diagram illustrating one example of the method of converting the Manage Section menu to the My Sections list as it is stored in the present invention;

FIG. 18 is a screen shot illustrating one example of the administration page of the present invention;

FIG. 19 is a screen shot illustrating one example of the Manage Conversations administration page of the present invention;

FIG. 20 is a screen shot illustrating one example of the Mange Comments system owner page of the present invention;

FIG. 21 is a screen shot illustrating one example of the Manage Links system owner page of the present invention; and

FIG. 22 is a screen shot illustrating one example of the Site Permissions system owner page of the present invention.

### DESCRIPTION OF THE REFERENCED NUMERALS

Turning now descriptively to the drawings, in which similar reference character denotes similar elements throughout the several views, the figures illustrate the Social Networking Application for Knowledge Sharing and Management of the present invention. With regard to the referenced numerals used, the following numbering is used throughout the various drawing figures.
10 Social Networking Application for Knowledge Sharing and Management of the present invention
12 search
14 advanced search
16 real simple syndication (RSS) feed
18 tag cloud
20 my sections
22 my actions
24 conversations archive
26 conversations preview
27 navigation tree
28 user sections
29 user sub-sections
30 user actions
32 save as draft
34 publish
36 select section
38 select section list
40 target audience
41 target audience list
42 tag
44 related content
46 related conversations
48 add related URL
50 relationship and content management (RCM) tool
52 criteria
54 section
56 user/group
58 add target audience
60 social network profile summary image
62 add to conversation
64 criteria conditions menu
66 external related content
67 external related content search
68 view conversations pate
70 comments
72 find related content
74 relationship and content management (RCM) content
76 conversation title
78 edit conversation
80 new comments
81 attachments
82 rating
84 administration page
86 create section
88 create sub-section
90 edit section
92 delete section
94 move section
96 all sections
98 all actions
100 manage sections page
102 section tree
104 manage conversation
106 manage conversation page
107 manage comments page
108 manage comments page
110 manage links page
112 manage links
114 site permissions page
116 site permissions
118 sections page
120 conversation template page

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments; practitioners skilled in the art will recognize numerous other embodiments as well. For definition of the complete scope of the invention, the reader is directed to the appended claims.

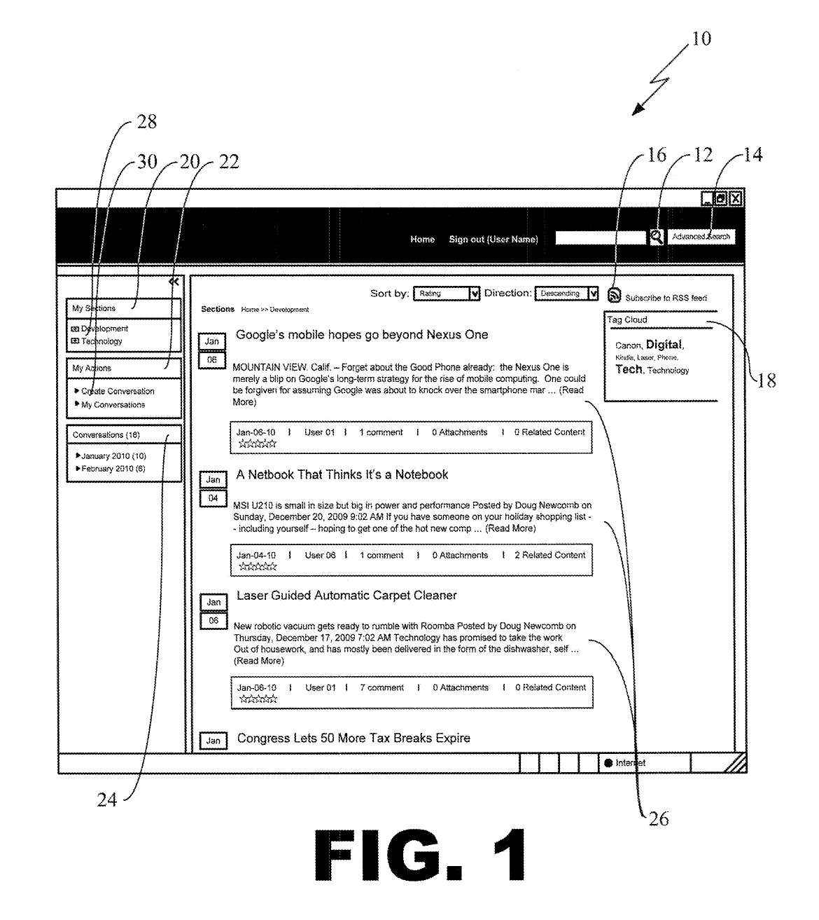

FIG. 1 is a screen shot illustrating one example of the basic features page of the present invention 10. Shown are the Search 12 and Advanced Search 14 features a user may use to search the present invention 10. These search features allow a user to simultaneously search all conversations as well as any comments, content, and attachments within those conversations. When a retrieved conversation is viewed by the user, the user will see the searched terms within the text of the conversation, its comments, content and attachments. These search functions may be built using various search technologies, including, but not limited to MICROSOFT Search Technologies. Also shown are the Conversations Previews 26 created by other users who have targeted the current user using Target Audience when creating a conversation. In the case of a Section Administrator or System Owner, the Section Administrator may see all conversations by all users within the Section the Section Administrator is an administrator of and the System Owner may see all conversations by all users. A user may create Conversations and view Conversations that are created by other users that the user has been granted permissions for. In this example, the options are My Sections 20, My Actions 22 and Conversations Archive 24. My Sections 20 are the User Sections 28 and Sub-Sections which are accessible by the user based on assigned permissions. The present invention 10 may be divided into User Sections 28 which represents a logical approach to organizing conversations. For example, User Sections 28 may be based on the various departments within an organization, such as, but not included to Development and Technology. My Actions 22 are the User Actions 30 a user may take using the present invention 10. These are menus containing the different options a user may have based on the user's permissions. These options allow a user to view or manage Conversations. A user may subscribe to Real Simple Syndication (RSS) 16 feeds based on Section or Conversation. This allows for real-time updates regarding the various conversations a user is targeted for. A user subscribing to feeds based on Conversations may see an update of any activity to a Conversation the user is targeted for; a user subscribing to feeds based on Sections may see an update of any Sections the user is a member of, including any sub-sections. This eliminates the need for a user to check the present invention's user interface and any email notifications. Also shown is a Tag Cloud 18 which represents the keywords that are associated with a Conversation. Each keyword is linked to all the Conversations that are associated with that keyword. The Tag Cloud 18 may display the keywords that are associated with the list of Conversation Previews 26 in the current view of the page.

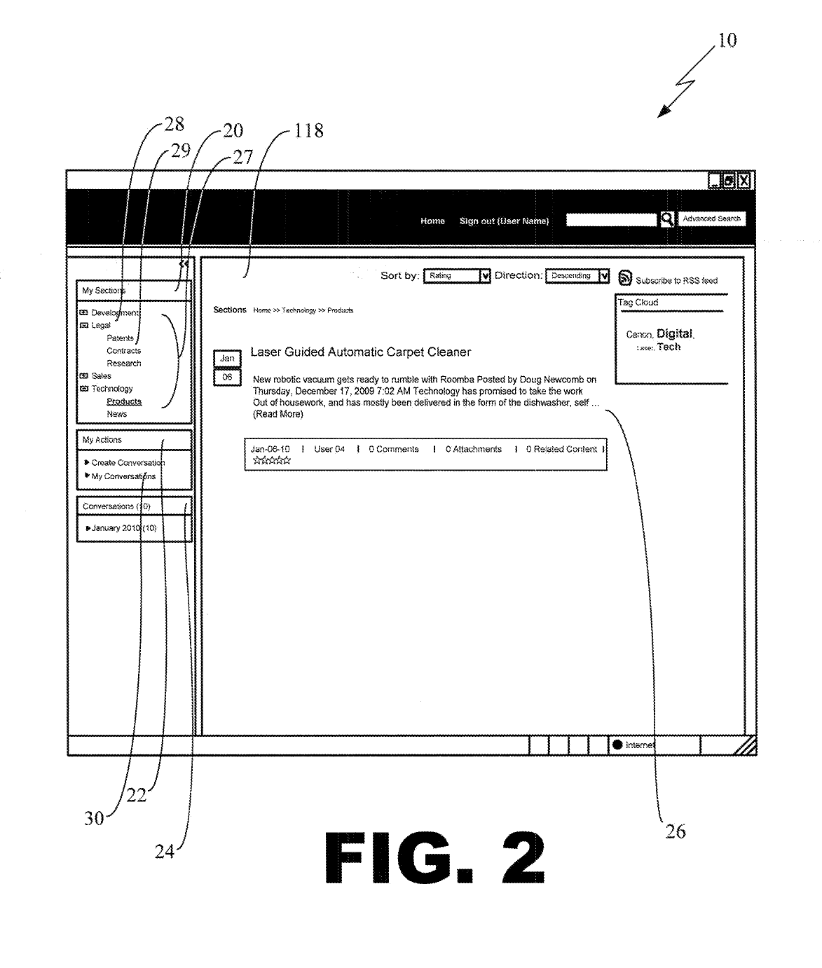

FIG. 2 is a screen shot illustrating one example of a Sections page 118 of the present invention 10. Shown under My Sections 20 are the User Sections 28 a user belongs to as well as User Sub-sections 29 in the form of a Navigation Tree 27. Users may belong to various Sections, which are based on permissions granted. Sections allow a user or Section Administrator to view and share conversations with other users in the same sections and, in addition, share conversations with specific target audiences outside the sections. This allows for users and Section Administrators to share Conversations with users or Section Administrators belonging to other Sections. The Navigation Tree 27 is based on a particular user's conversations and Sections and is dynamic based on each user of the present invention. For example, the present example shows a user having permissions for the development, legal, sales, and technology sections. An alternate user having different permissions may have displayed in this Navigation Tree 27 the same, different or a combination of other sections and sub-sections used by an organization. Also shown are User Actions 30 that the user may take regarding conversations within the present invention 10. The options displayed are dependent on the permissions of the current user. The present example shows the actions this particular user may take, which include creating a conversation under Create Conversations and managing the user's own Conversations under My Conversations. The present invention 10 may archive and save all Conversations daily. The archived Conversations may be viewed in the Conversations Archive 24, which is also shown.

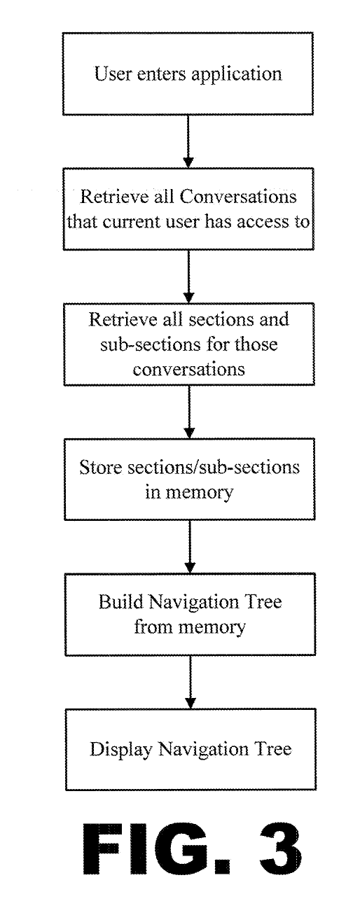

FIG. 3 is a flow diagram illustrating one example of how the present invention may build a Navigation Tree for a current user based on the user's conversations and sections. The user first enters the present invention and the appropriate permissions are distinguished and the user accessible conversations are retrieved. All sections and sub-sections may be retrieved for those conversations. The relevant information from these sections and sub-sections are stored in memory, such as a data table. The section information contains information regarding the parent-child relationships between sections and sub-sections. The ECMC platform uses this information to build a hierarchy of sections and sub-sections. A Navigation Tree may be built from this data table on the fly based on the permissions set for each user as well as the sections and sub-sections created by Section Administrators and System Owners. The Navigation Tree 27 is displayed under My Sections 20 as shown in FIG. 2. The Navigation Tree may be customizable by the System Owner using ASP NET pages. This Navigation Tree is specific to each user based on the conversations that user is allowed to see or participate in.

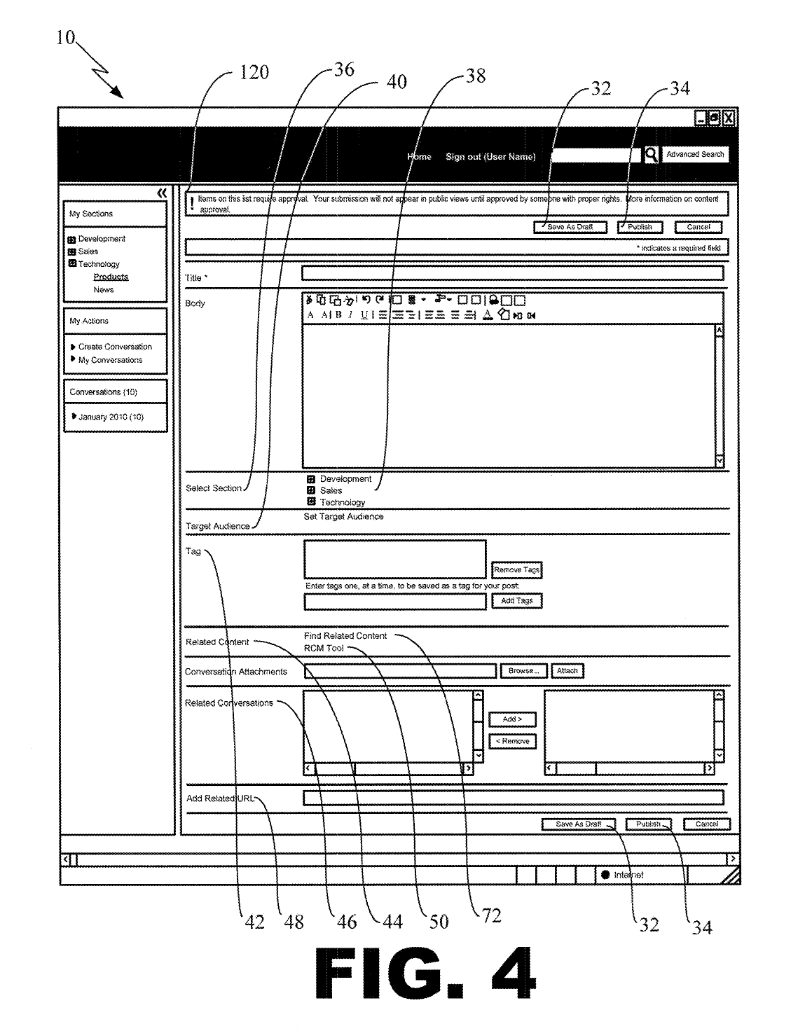

FIG. 4 is a screen shot illustrating one example of the Conversation Template Page 120 a user may see when creating a Conversation in the present invention 10. The user may have the options to save the Conversation using Save As Draft 32 or Publish 34 the Conversation. If the conversation is saved as a draft, other users may not be able to view the Conversation until the author of the Conversation publishes the Conversation. The user may use Select Section 36 to select the Section to which the Conversation is directed as a Target Audience. Target Audience 40 allows the user to select the type of user they would like to share the Conversation with. The Section Administrator of that Section and System Owners may see unpublished drafts. All users within the Target Audience 40 may be able to view, rate and leave comments on that Conversation. When creating a Conversation, the user may link the Conversation to other Conversations which are available under the Related Conversations 46 list. The user may also add Tags 42 to the related Conversations which may appear in the Tag Cloud. The Tags 42 allow for the retrieval of Related Conversations 46 as well as Related Content 44. The Conversations may be shared with users from the same Section, other Sections, and users not belonging to any Sections using Target Audience 40. Using Find Related Content 72, the present invention 10 may do an external web service search and produce various websites which match all the Tags 42 entered by the user. Furthermore, user levels may be based on Tags 42. The usefulness of a user's contributions to the conversation in all knowledge areas may be designated as user levels. User levels contain the ability to have “n” number of levels and be dynamic. User levels may also contain the ability to set a threshold for each level needed that designates a user level. Users may receive their user level based on the usefulness rating the user's conversations, usefulness of rating comments, and the frequency of contribution, all of which may meet a threshold value. Add Related URL 48 may add the link within the Conversation to the websites that the user wishes to add. These websites may be available from the Related Content 44 feature when a user views a Conversation. The present invention 10 may also be linked to an RCM Tool 50 providing for easy uploading of business content to a conversation for organizations utilizing Enterprise Content Management Solutions. In various implementations, the ECM Solution may be CLEARVIEW SOFTWARE. The utilization of an RCM Tool 50 to upload related content and attachments provides for the maintenance of security regarding business content as well as ease of content search and retrieval. Furthermore, the present invention 10 allows for uploading non RCM Content. The present invention 10 is able to compare any uploaded attachments with any uploaded RCM Content before conversation publishing is allowed to ensure against duplicate content within a conversation. Users authoring Conversations may edit their Conversations; Section Administrators and System Owners may have the privilege of editing the Conversations that are created by other users in the Section.

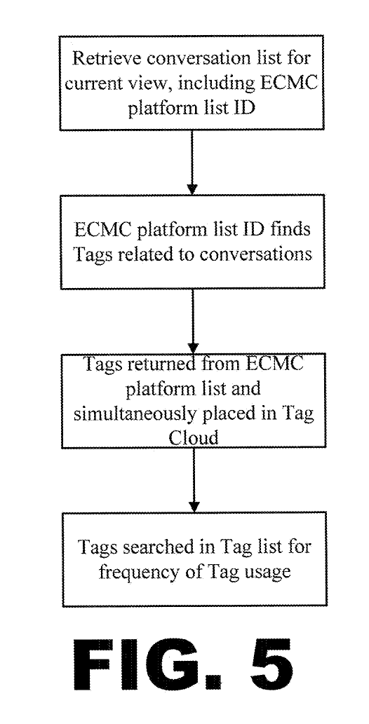

FIG. 5 is a flow diagram illustrating the process by which a Tag Cloud may be built in the present invention. Tags are keywords associated with conversations within the present invention. As a user browses through the various conversations available to that particular user, the user may utilize a Tag Cloud as a filter mechanism allowing for the filtering of conversations based on the Tags of those conversations. A Tag Cloud may be displayed when multiple conversations are displayed at the same time, meaning that the Tag. Cloud may represent all the Tags for every conversation displayed in a current view. Tags are items stored in an ECMC platform list, such as MICROSOFT SHAREPOINT LIST ITEMS. Through the ECMC platform, Tag Clouds inherit the security applied to conversations because they show the Tags for conversations in the current view and users may only see the conversations they have access to. The process includes first retrieving the list of conversations for the current view using the ECMC platform. For each conversation, the ECMC platform list ID may be used to find all Tags related to that particular conversation. The ECMC platform list ID may then look up all Tags using an internal tracking list having an entry for each conversation, which may track all Tags for that conversation. The Tags may then be returned from the ECMC platform list and placed in the Tag Cloud. Once all Tags for the current view are known, the frequency of the Tags are searched, in a Tag list to determine frequency of usage for the various Tags and simultaneously returns the tag frequency information. The Tags list determines how many times the Tags have been used within the present invention and uses that frequency to resize the Tags in the Tag Cloud based on frequency of use.

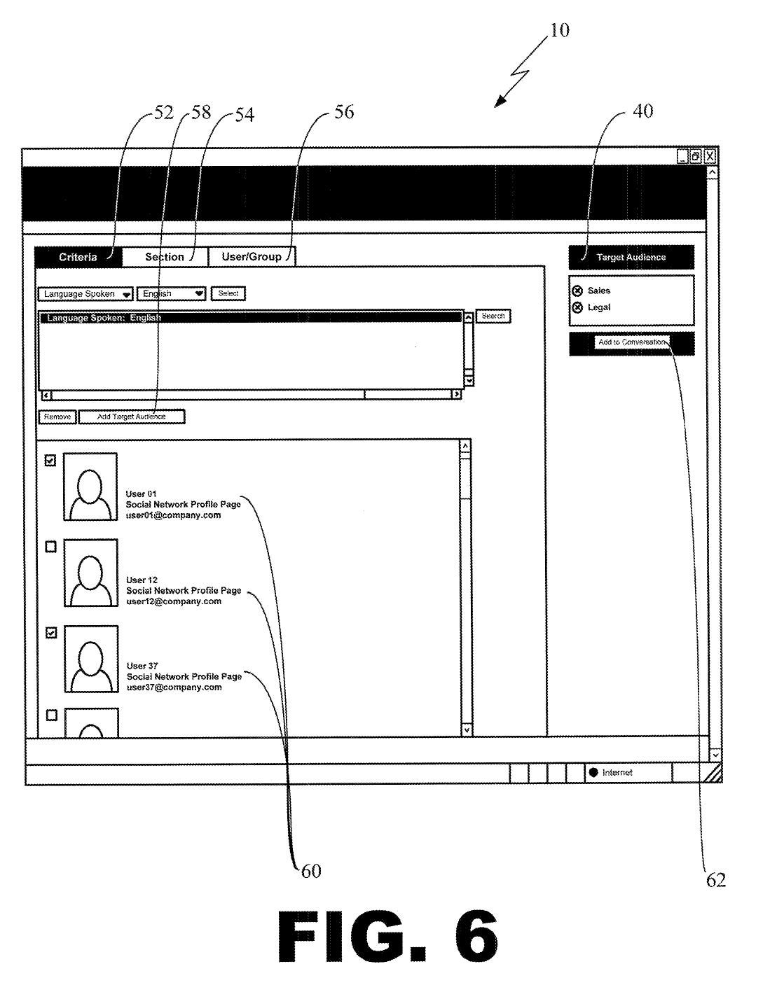

FIG. 6 is a screen shot illustrating one example of the Criteria 52 conditions of the Target Audience 40 feature of the present invention 10. When creating a Conversation, a user may share Conversations with any audience the user wishes to target. Shown are the possible categories of Criteria 52, Section 54 and User/Group 56. An organizations hierarchal structure may be used when creating target audiences. For example, a conversation may be accessed by all subordinates of a user or all upper level management members. Additionally, multiple categories may exist for determining a target audience. The user may leverage any Social. Network Profile properties available and apply filtering to the conditions presented due to the different weights applied to conditions. For example, one may want to find users who have certain certifications. Under Criteria 52, users may be searched based on conditions selected from a menu. Shown is the user search Criteria 52 of English as the language spoken. This selection may search all users associated with an organization having English as the language spoken within an organization's internal or external Social Network Profile P. In the present example, all users speaking English may have their Social Network Profile Summary Image 60 appear, from which the Conversation creating user may select individual users to be added to the Target Audience using Add Target Audience 40. The Social Network Profile Summary Image 60 may include an image of the searched user, their Social Network Profile Page link and email. System Owners may create the available Criteria 52 used in searching for users for Target Audience 40 purposes.

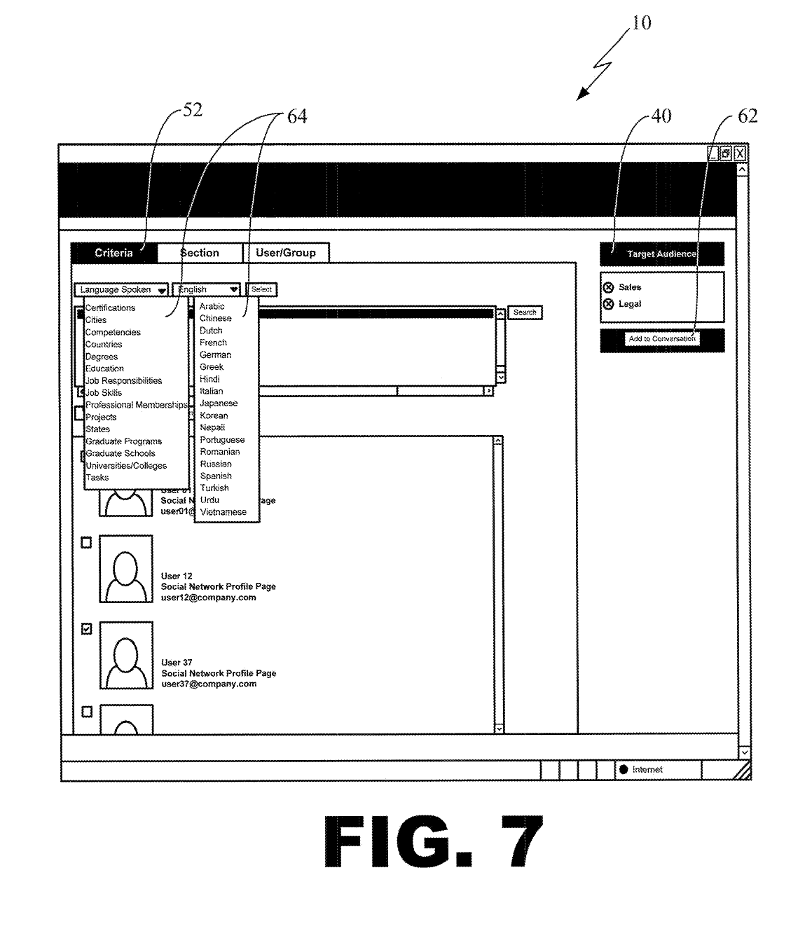

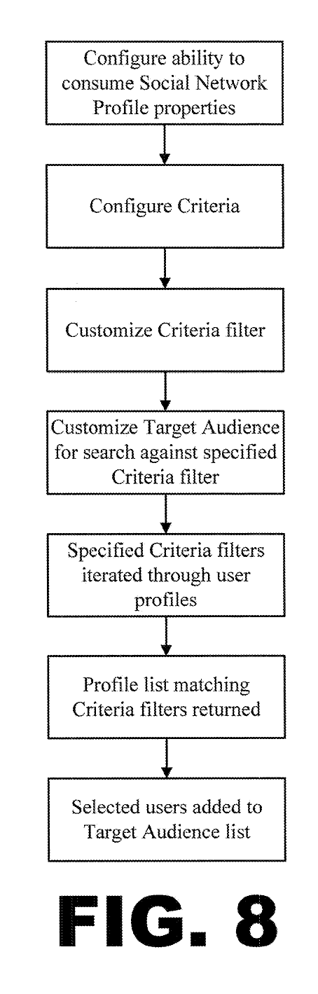

FIG. 7 is a screen shot illustrating one example of the Criteria Condition Menus 64 for the present invention 10. FIG. 8 is a flow diagram illustrating one example of the process followed by the Criteria conditions of the Target Audience feature of the present invention. Users may select the various Criteria 52 conditions configured by the System Owner in order to search for the pertinent user qualifications displayed in each user's Social Network Profile Page. Shown are the various criteria made available by a current System Owner. A System Owner may customize the Target Audience 40 to search against Criteria 52. These Criteria 52 may be based on user information contained in Social Network Profiles, including, but not limited to, MICROSOFT SHAREPOINT USER PROFILES. A System Owner may create custom user profile properties outside of Social Network Profiles. The present invention 10 may be configured to any type of Social Network Profile. The ECMC platform may contain properties having an associated choice list. For example, under the custom property of “Languages Spoken” may exist a predefined choice list containing all available languages. Once a user has chosen the desired Criteria filter, it may be added to the user's Criteria selection along with any other Criteria selected. The present invention may then take the Social Network Profile property Criteria the user has specified and iterate through every Social Network Profile Page that may exist and return all users who match that Criteria. The returned users may be selected by the current user for placement in the Target Audience 40.

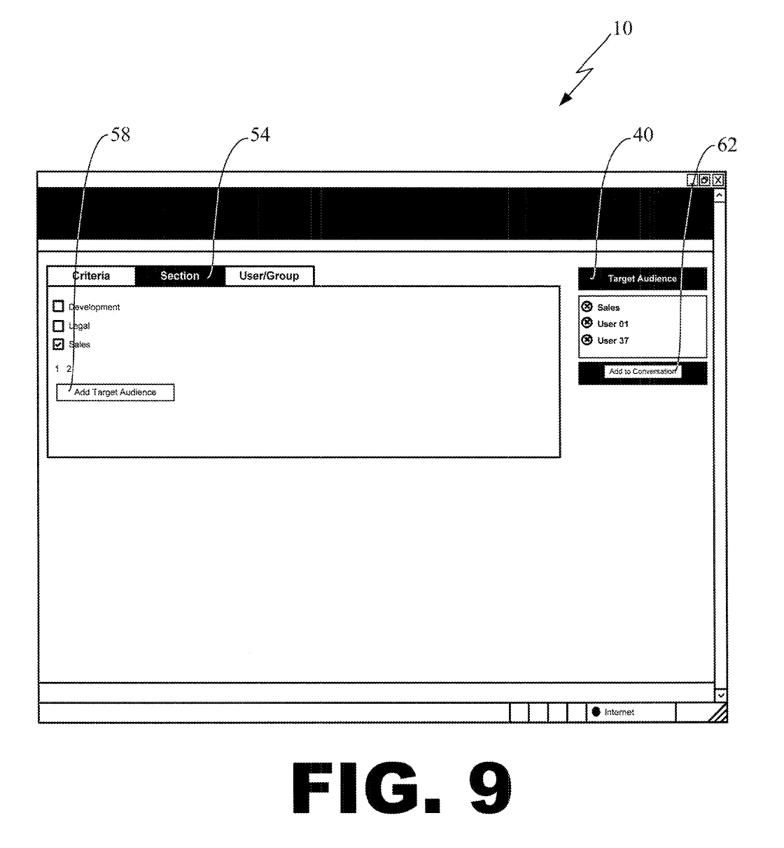

FIG. 9 is a screen shot illustrating one example of the inclusion of the possible target audience of the Section 54 category of the present invention 10. A list of sections created by the System Owner may be presented. The user may select a section, or multiple sections, so that the users within it may be selected as a target audience and be granted the required permissions to view the Conversation being created. A user may select from the Sections within the present invention 10 representing each root section that has been created by a System Owner. Each section may have two ECMC platform groups associated with it. One may be for section users and one for Section Administrators. Selecting a Section 54 may add the two groups to the Target Audience 40. Shown is a user selection of the Sales section, meaning that every user within the Sales section is selected as a target audience for the conversation being created.

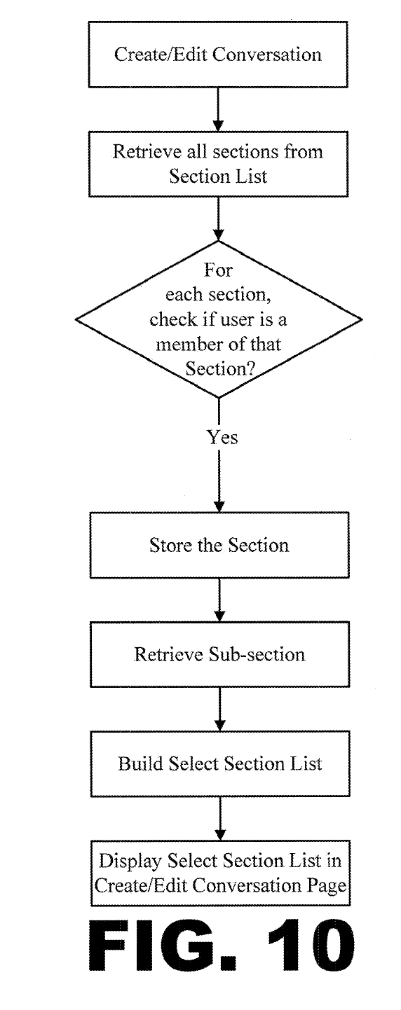

FIG. 10 is a flow diagram illustrating the method for building the Select Section list, as in FIG. 4, seen when starting a conversation based on a user's permission level. A user first creates or edits a conversation. All sections from a Section List may then be retrieved. For each section created by the System Owner, the present invention checks if the current user is a member of that section. If the user is a member of any selected sections, the section is stored. The sub-section may be retrieved if in existence. A Select Section List is built and may be displayed in the Create/Edit conversations page (FIG. 4).

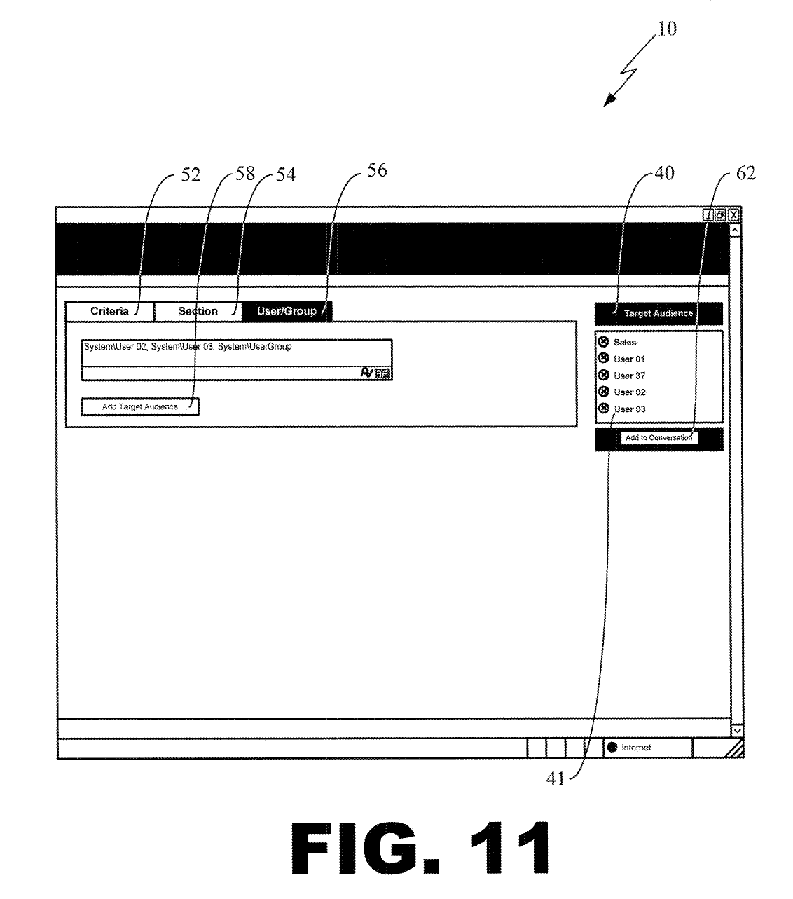

FIG. 11 is a screen shot illustrating one example of the inclusion of the possible target audience of the User/Group 56 category of the present invention 10. Users may select users and groups that may be found in an organization's active directory. The user may enter another user's name or a group name. This enables the users who are listed to view the conversations they are targeted for. Add to Conversation 62 adds the Target Audience List 41 to the conversation for user access to the conversation.

Once the user has selected a Target Audience 40 using Criteria 52, Section 54 and User/Group 56, the present invention 10 may go through the list of users and groups that have been added to the Target Audience List 41 and gives those users and groups the appropriate permissions to the conversation using the ECMC platform permission capabilities to apply the permissions to the conversation. In various implementations, the ECMC platform permission capabilities may be MICROSOFT SHAREPOINT list items. All emails for all users in the Target Audience List 41 may be retrieved and notification emails regarding activity to the conversation may be sent to the Target Audience 40.

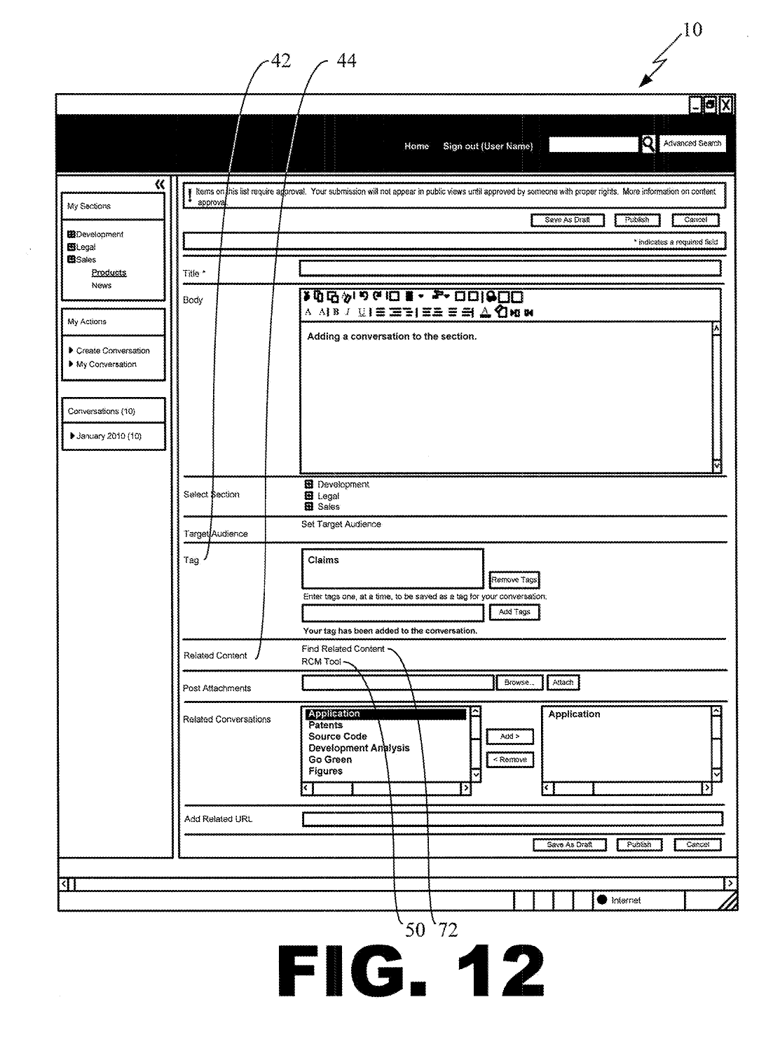

FIG. 12 is a screen shot illustrating one example of adding related and external content to a Conversation in the present invention 10. When creating a Conversation, a user may add related content from other websites and link those to the Conversation using Find Related Content 72. The websites are searched using the user defined Tags 42 as the search criteria in an external internet search engine. The present invention 10 is able to retrieve the related websites and the user may select which links to add within a conversation. Shown is the user Tag 42 of “Claims”. Anytime an alternate user places the word “Claims” as a criteria for searching the present invention 10, the Conversation containing the Tag 42 will be found. As a user selects Tags 42, the related conversations are pulled and viewable by the user. During the process, the Tags 42 may be filtered based on the conversations a user is viewing. Tag 42 filtering allows for custom security measures in conversations by dynamically updating a current view of conversations based on the associated Tags 42.

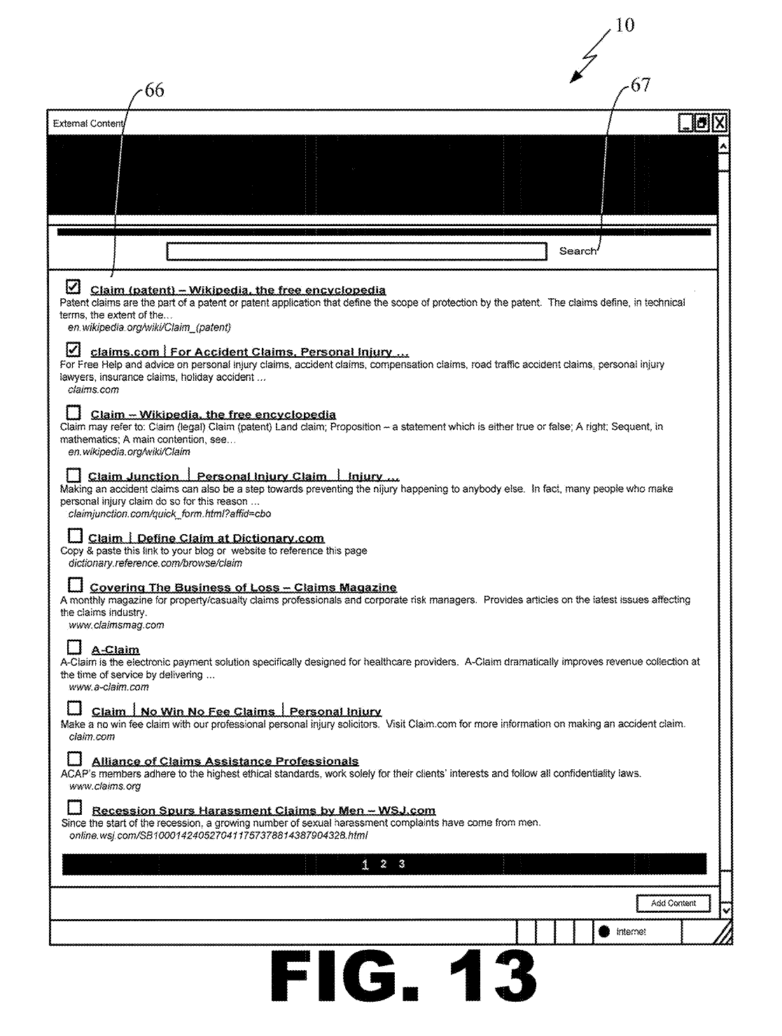

FIG. 13 is a screen shot illustrating one example of the External Related Content 66 search that may result by user selection of Find Related Content of the present invention 10. Selecting Find Related Content from FIG. 8 may open a new window with a list of websites that match all of the Tags created for the Conversation. Shown are the various websites that are found-relating to “Claims,” which was a Tag in the example used in FIG. 8. The user selected websites are placed in a Related Content tab of the Conversation. The user may perform a further search of external content by placing terms in the External Content Search 67 field. This enables a user to look for external content without the use of Tags or in addition to the use of Tags.

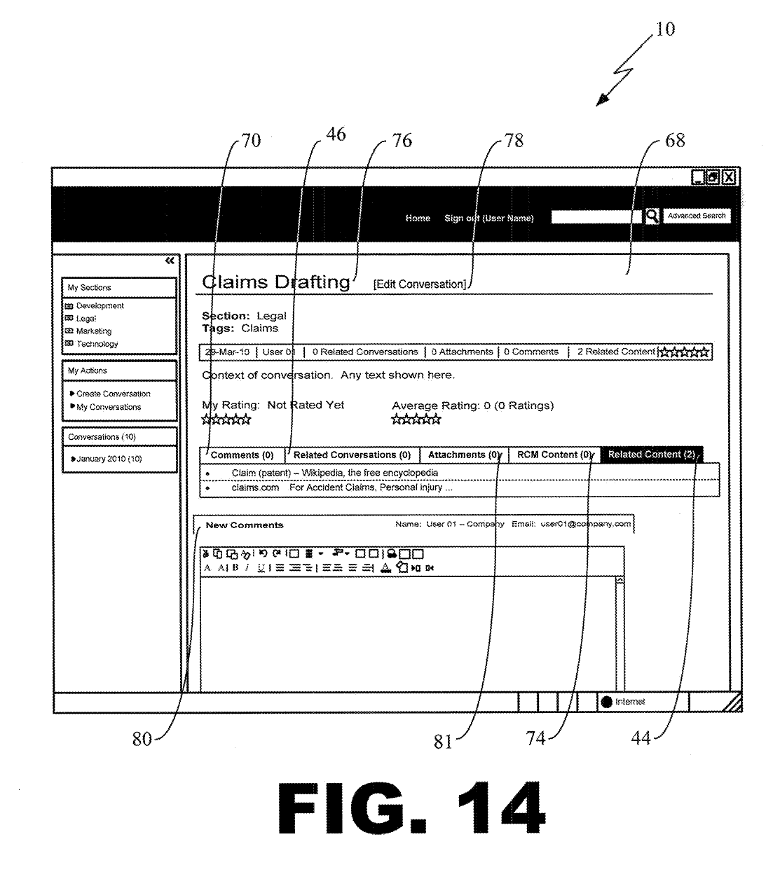

FIG. 14 is a screen shot illustrating one example of the related and external contents links displayed within a Related Content 44 tab of a conversation's View Conversation Page 68 of the present invention 10. Selection of a Conversation Title 76 allows for the viewing of the contents of the conversation. An alternate user may leave comments, rate the conversation and any comments, view Comments 70, view Related Conversations 46, and view uploaded RCM Content 74 and Attachments 81. If the conversation being viewed is by the author, Section Administrator or System Owner, an Edit Conversation 78 option may be visible. Shown are two external websites in Related Content 44 selected by the user through Find Related Content. Users targeted for the specific conversation may create New Comments 80.

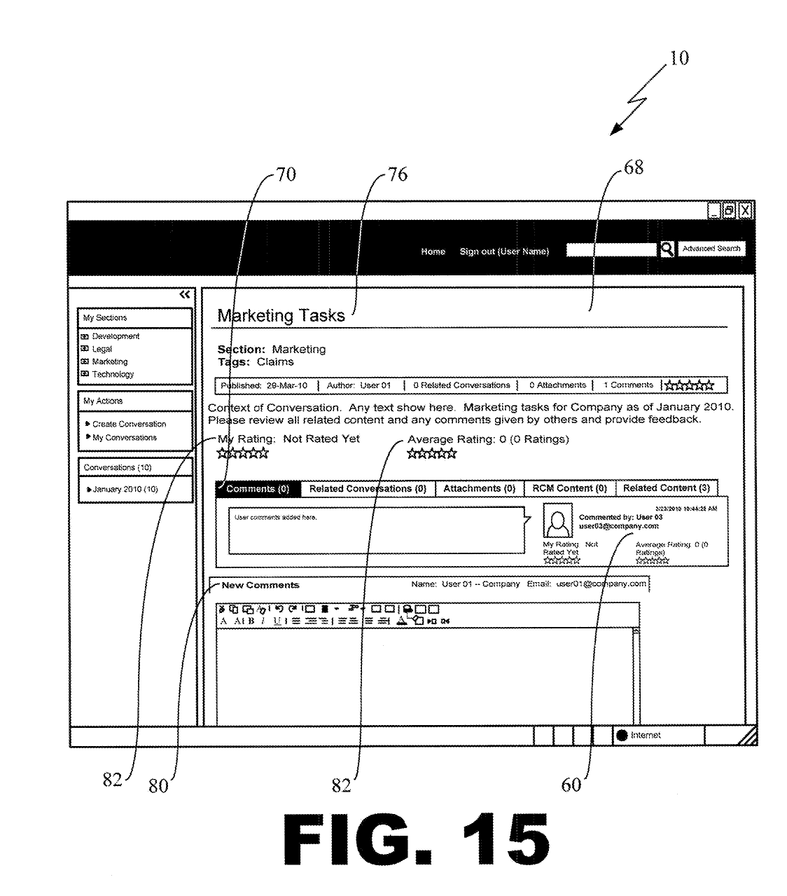

FIG. 15 is a screen shot illustrating one example of the Comments 70 portion of the View Conversation Page 68 of the present invention 10. Shown are comments added by a user. Also shown is the user's Social. Network Profile Summary Image 60 information and comment left by that user. Also shown is the add comment template where additional users may leave New Comments 80. Here, a user may also rate the conversation using Ratings 82. Comments may be rated on usefulness and allow for attachments to be added in support of any comments made.

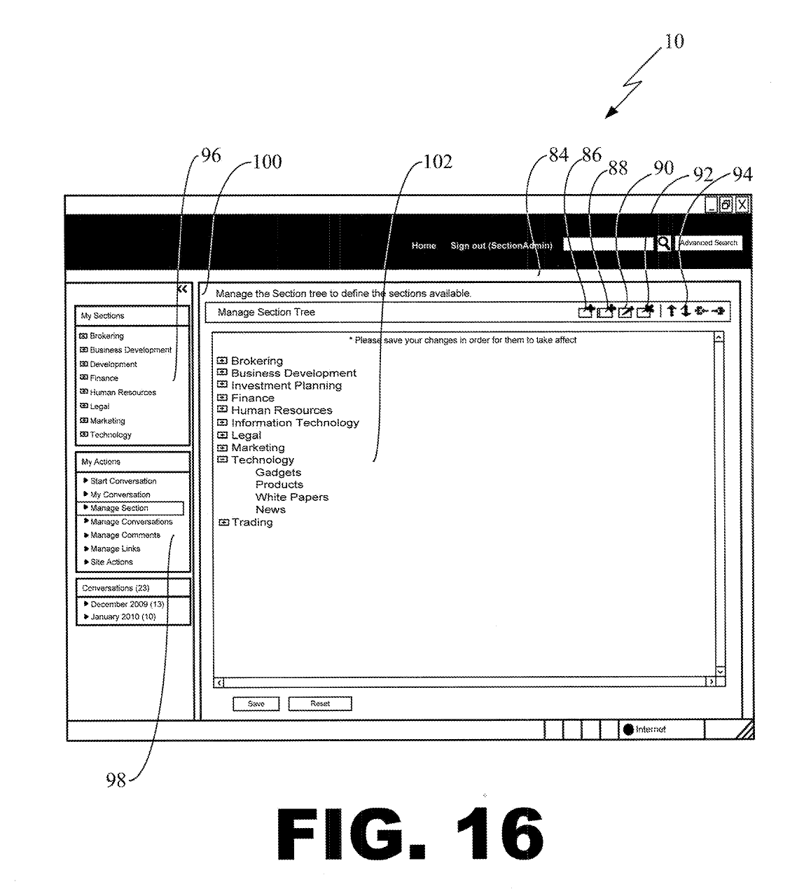

FIG. 16 is a screen shot illustrating one example of the Administration Page 84 of the present invention 10 that may be viewable by a Section Administrator and System Owner. Under My Actions, both may also have additional options to manage various aspects of the present invention; All Actions 98 available to a Section Administrator and System Owner are shown. Shown is the page for Manage Section 100. Section Administrators and System Owners may Create 86, Edit 90, Move 94 and Delete 92 Sections. Section Administrators may view Sections they are administrators of. System Owners may view All Sections 96 that have been created. System Owners have the privileges of creating and deleting All Sections 96. Shown are the possible System Owner configurable Sections of Brokering, Business Development, Investment Planning, Finance, Human Resources, Information Technology, Legal, Marketing, Technology and Trading. Also shown are the Sub-Sections of Technology. Shown is an example of a Section Tree 102 defining the sections and any sub-sections that may be available.

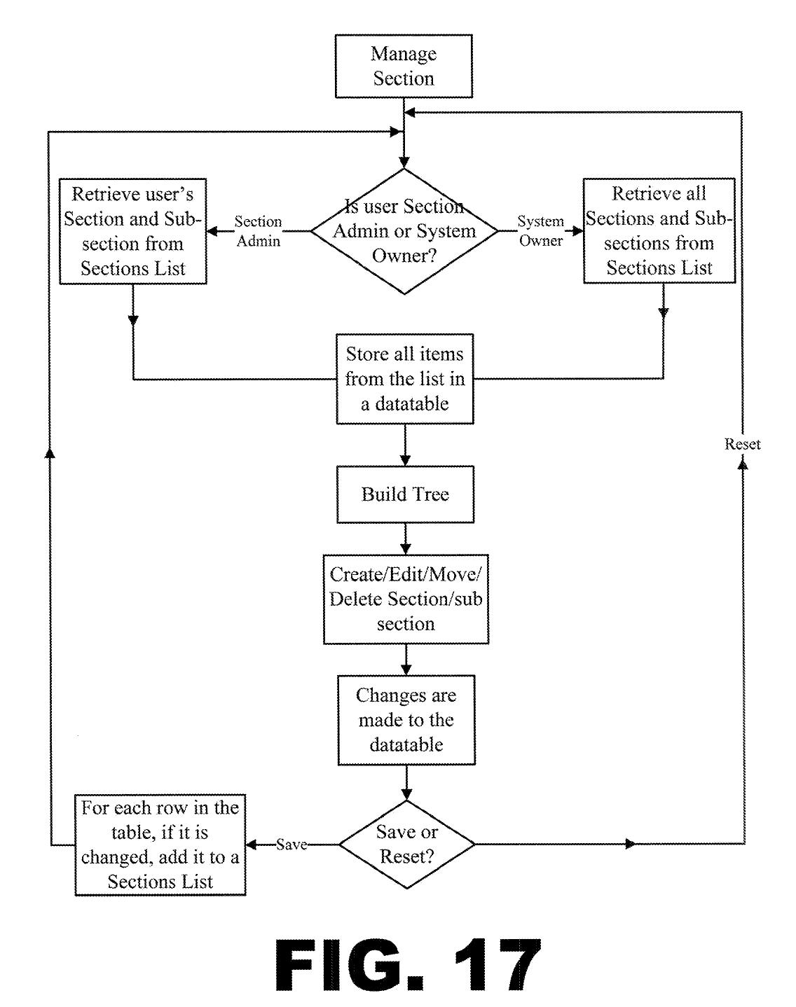

FIG. 17 is a flow diagram illustrating one example of the method of converting the Manage Section menu from FIG. 16 to the My Sections list as it is stored in the ECMC platform. If the current user is a Section Administrator, the Section Administrator's administrative sections and sub-section may be retrieved from a Section List. All items from the Sections List are stored in a database. The content tree is then built and a section or sub-section may be created, modified, moved, and deleted. These changes are made to the data table. If the Section Administrator saves these changes, each changed row in the data table may be added to a category list. If the Section Administrator resets the changes, the process may be commenced again.

If the current user is a System Owner, all sections and sub-sections contained in the present invention may be retrieved from a Sections List. All items from the Sections List are stored in a database. The tree is then built and a section or sub-section may be created, modified, moved, and deleted. These changes are made to the data table. If the System Owner saves these changes, each changed row in the data table may be added to a Section List. If the Section. Administrator resets the changes, the process may be commenced again.

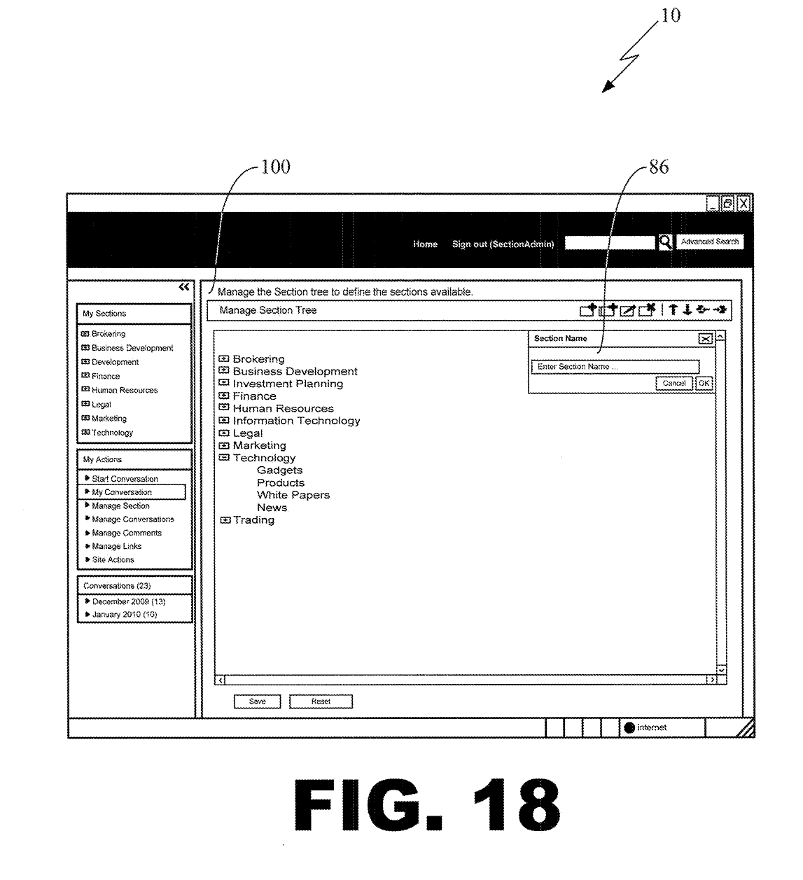

FIG. 18 is a screen shot illustrating one example of the administration page of the present invention 10. Shown is a window which may be provided to Create a Section 86 or Sub-Section.

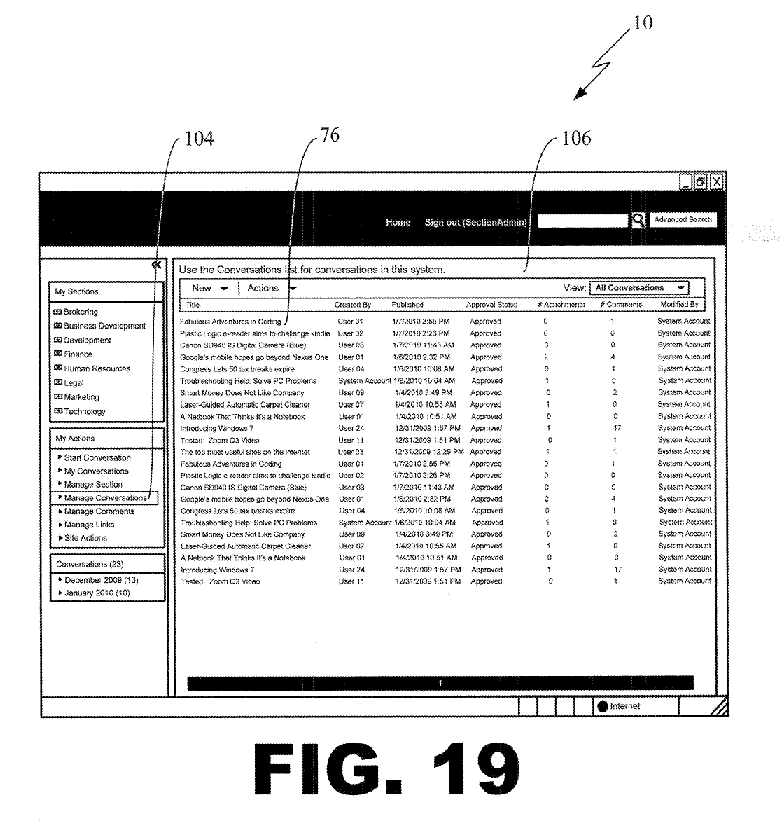

FIG. 19 is a screen shot illustrating one example of the Manage Conversations Page 106 of the administration page of the present invention 10. The Section Administrators and System Owners may create new conversations, view a conversation, edit existing conversations and delete existing conversations. Shown is the Manage Conversations Page 106 which may contain a listing of all the conversations created within a particular Section or the whole System. The Section Administrators may select any of the Conversation Titles 76 within their administrative section and System Owners may select any of the Conversation Titles 76 in the present invention for performing the above tasks.

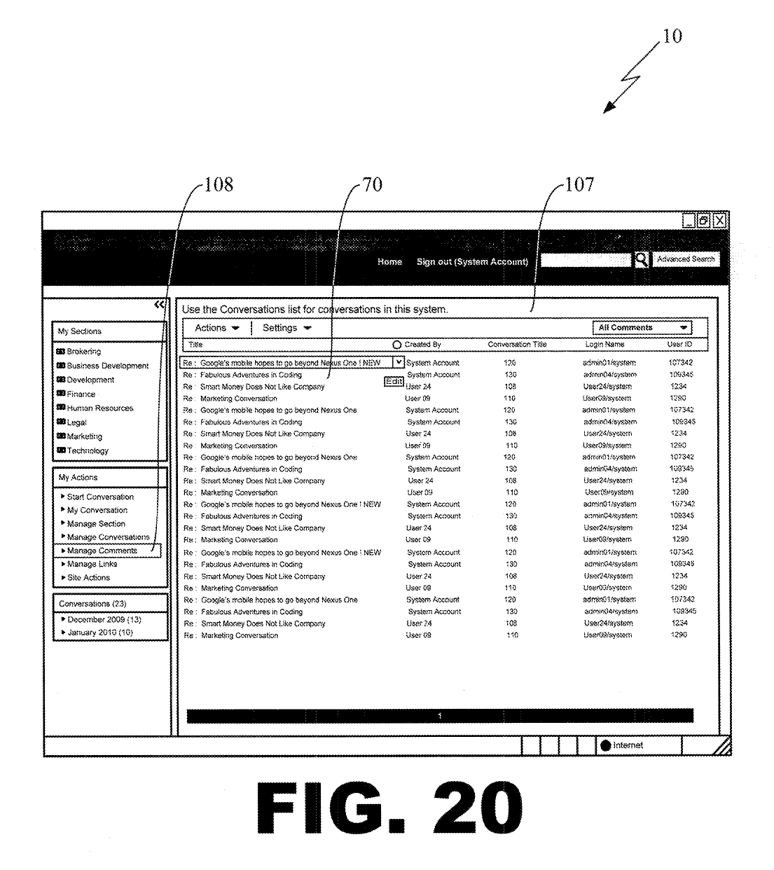

FIG. 20 is a screen shot illustrating one example of the Manage Comments Page 107 of a system owner page of the present invention. System Owners may manage Comments 70 left by other users and Section Administrators. System Owners may view, edit and delete comments using this page.

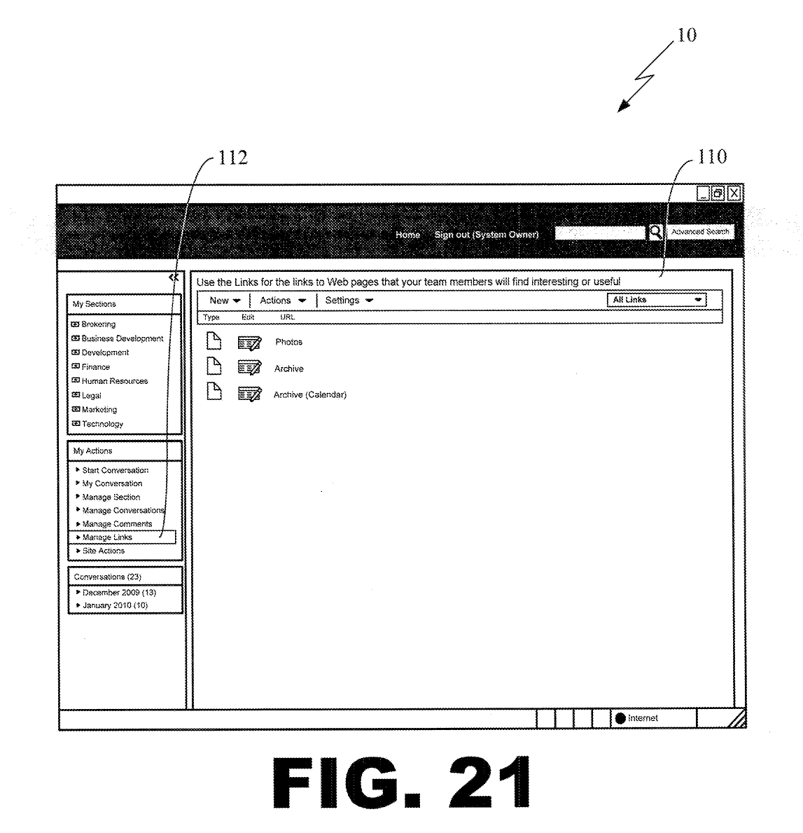

FIG. 21 is a screen shot illustrating one example of the Manage Links Page 110 of the System Owner's page of the present invention 10. System Owners may manage existing links that are viewable by the users which the System Owner grants permissions to. System Owners may update links on the fly depending upon the System Owner's usage of this feature. This feature allows the System Owner to customize the links which users may see.

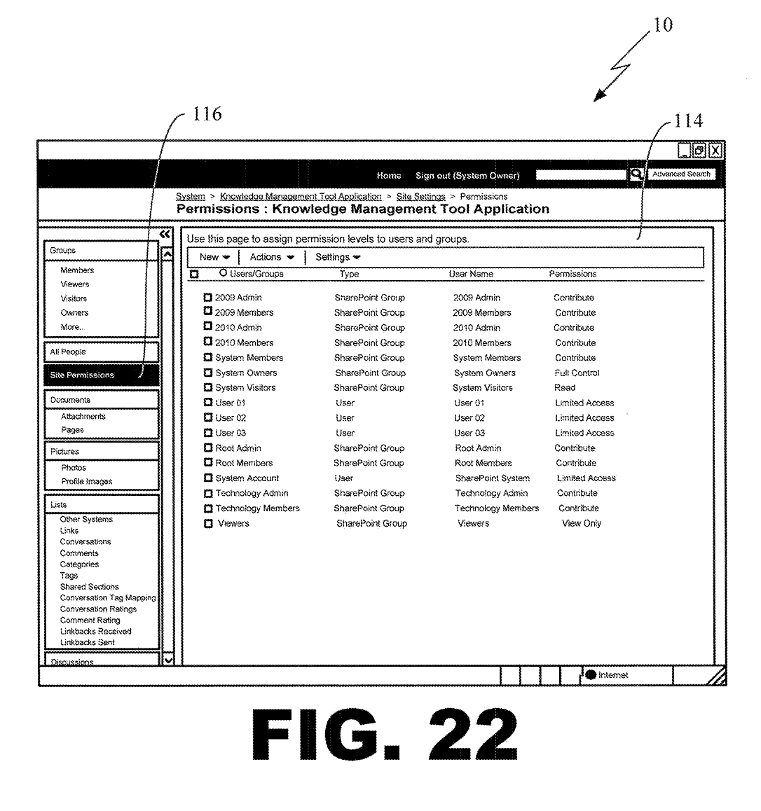

FIG. 22 is a screen shot illustrating one example of the Site Permission Page 114 of a system owner's page of the present invention 10. Site Permissions 116 may be used to set up and manage users in a group and their permissions settings. Shown is a listing of the various users within an organization along with the type of user that particular person is as well as the permissions that user is allowed. User permissions may be adjusted by the System Owner.

What is claimed is new and desired to be protected by Letters Patent and is set forth in the appended claims:

1. A Social Networking Application for Knowledge Sharing and Management comprising a web-based interface; templates housing information for a systems interface; a means for creating interactive conversation and content for specified users; a means for targeting said specific users; a means for filtering said interactive conversations and content; a means for linking said interactive conversations and content to other interactive conversations and content; a means for retrieving content; a means for creating user contribution-based dynamic user levels; a means for providing real-time updates to any activities of said interactive conversation and content for specified users; and a means for providing notifications.

2. The Social Networking Application for Knowledge Sharing and Management according to claim 1, wherein said web-based means for creating interactive conversations and content for specified users is permissive based.

3. The Social Networking Application for Knowledge Sharing and Management according to claim 1, wherein said means for targeting specific users comprises creating configurable categories and search conditions.

4. The Social Networking Application for Knowledge Sharing and Management according to claim 3, wherein said specified users are targeted for access to said interactive conversation and content.

5. The Social Networking Application for Knowledge Sharing and Management according to claim 3, wherein said means for targeting specific users further comprises a means for searching and retrieving user information for satisfying said configurable categories and search conditions from a user social network profile.

6. The Social Networking Application for Knowledge Sharing and Management according to claim 1, further comprises a means for interactive rating and commenting by users.

7. The Social Networking Application for Knowledge Sharing and Management according to claim 1, wherein said means for filtering said interactive conversations and content comprises tagging.

8. The Social Networking Application for Knowledge Sharing and Management According to claim 7, wherein said means comprises retrieving a list of conversations; finding tags related to particular conversations; retrieving all system tags using internal tracking lists having an entry for each conversation; searching the frequency of all tags; simultaneously return tag frequency information; and displaying of user filtered conversations and content.

9. The Social Networking Application for Knowledge Sharing and Management according to claim 1, wherein said means for retrieving content comprises searching content related to said interactive conversation from an external web-based search engine; retrieving web-page links from search from external web-based search engine; searching said retrieved web page links for related content; and creating said web-page link within said interactive conversation.

10. The Social Networking Application for Knowledge Sharing and Management according to claim 9, wherein said means further comprises searching content related to said interactive conversation from an external web-based search engine using tags.

11. The Social Networking Application for Knowledge Sharing and Management according to claim 1, wherein said means for linking said interactive conversations and content to additional interactive conversations and content comprises linking using tags.

12. The Social Networking Application for Knowledge Sharing and Management according to claim 1, further comprising a means for creating a dynamic navigation tree on the fly based on user permissions.

13. The Social Networking Application for Knowledge Sharing and Management according to claim 12, wherein said means comprises distinguishing appropriate user permissions, accessible conversations and content; retrieving said user accessible conversations; retrieving sections and sub-sections for said permissions, accessible conversations and content; storing meta information from said sections and sub-sections in memory; building a hierarchy of sections and sub-sections; building a navigation tree on the fly using said meta information based on said permissions, accessible conversations and content; customizing said navigation tree.

14. The Social Networking Application for Knowledge Sharing and Management according to claim 1, further comprising a means for management of user permissions and actions.

15. A Social Networking Application for Knowledge Sharing and Management comprising a means for locating, comparing, displaying and linking content to conversations from relationship and content management repositories.
